(19) United States
(12) Patent Application Publication
(10) Pub. No.: US 2013/0268271 A1
(43) Pub. Date: Oct. 10, 2013

(54) SPEECH RECOGNITION SYSTEM, SPEECH RECOGNITION METHOD, AND SPEECH RECOGNITION PROGRAM

(71) Applicants: Seiya Osada, Minato-ku (JP); Ken Hanazawa, Minato-ku (JP); Koji Okabe, Minato-ku (JP)

(72) Inventors: Seiya Osada, Minato-ku (JP); Ken Hanazawa, Minato-ku (JP); Koji Okabe, Minato-ku (JP)

(73) Assignee: NEC CORPORATION, Minato-ku, Tokyo (JP)

(21) Appl. No.: 13/994,462

(22) PCT Filed: Dec. 22, 2011
(86) PCT No.: PCT/JP2011/007203

§ 371 Date: Jun. 14, 2013

(30) Foreign Application Priority Data
Jan. 7, 2011 (JP) 2011-002307

(51) Int. Cl. G10L 15/065

(52) U.S. Cl. CPC G10L 15/065
USPC 704/240

(57) ABSTRACT

A speech recognition system has: hypothesis search means which searches for an optimal solution of inputted speech data by generating a hypothesis which is a bundle of words which are searched for as recognition result candidates; self-repair decision means which calculates a self-repair likelihood of a word or a word sequence included in the hypothesis which is being searched for by the hypothesis search means, and decides whether or not self-repair of the word or the word sequence is performed; and transparent word hypothesis generation means which, when it is decided that the self-repair is performed, generates a transparent word hypothesis which is a hypothesis which regards as a transparent word a word or a word sequence included in a disfluency interval or a repair interval of a self-repair interval including the word or the word sequence.

### TECHNICAL FIELD

The present is concerning a speech recognition system, a speech recognition method, and a speech recognition program.

### BACKGROUND ART

In recent years, an application of a speech recognition technique develops, and a speech recognition technique is used for a reading utterance from people to machines and a more natural utterance from people to people.

Causes of false speech recognition include a self-repair phenomenon. Self-repair refers to a phenomenon that a given word sequence is uttered as is or replaced with another word sequence and uttered.

Hereinafter, it is assumed based on a model (repair interval model) disclosed in Non-Patent Literature 1 that an interval related to self-repair is classified into three intervals of a reparandum interval, a disfluency interval and a repair interval, and continue. The reparandum interval refers to an interval which is repaired upon a subsequent speech. Further, the repair interval refers to a speech interval for repairing preceding speech interval. Furthermore, a disfluency interval refers to an interval in which, although a preceding speech interval is not corrected like hesitation or an interjection, some sound is uttered after the reparandum interval and the repair interval to connect to the subsequent repair interval. When, for example, “I like an apple, oh, a banana” is inputted, an “apple” portion is a reparandum interval, a “oh” portion is a disfluency interval and a “banana” portion is a repair interval. In addition, the reparandum interval is referred to as a “un-repaired interval” in some cases. Further, by contrast with this, the repair interval is referred to as a “self-repaired interval” in some cases. In addition, the disfluency interval is included in the un-repaired interval in some cases, and is included in the self-repaired interval in some cases. Further, the disfluency interval is included in none of these intervals and is another interval, or is omitted. Hereinafter, an interval from a reparandum interval to a repair interval is simply referred to as a “self-repair interval” in some cases.

Further, Non-Patent Literature 2 discloses a language analysis system which uniformly analyzes sentences having ill-formedness such as self-repair. The system disclosed in Non-Patent Literature 2 is a system which analyzes a language of an inputted text, and which expands a modification.

### CITATION LIST

### Non-Patent Literatures

NPL 1: Nakatani, C. and Hirschberg, J, “A speech-first model for repair detection and correction”, Proceedings of the 31st annual meeting on Association for Computational Linguistics, 1993, p. 46-53
NPL 2: DEN, Yasuharu, “A uniform approach to spoken language analysis”, Journal of Natural Language Processing Volume 4 Number 1, 1997, p23 to 40

### SUMMARY OF INVENTION

### Technical Problem

However, although a language analysis system generally analyzes the language referring to long distance information like modification analysis as disclosed in Non-Patent Literature 2, a speech recognition system generally uses a N-gram language model as a language model. Hence, the speech recognition system which uses the N-gram language model cannot refer to long distance information, and uniformly analyze speech having ill-formedness such as self-repair.

It is therefore an object of the present invention to provide a speech recognition system, a speech recognition method and a speech recognition program which are robust against self-repair even when an N-gram language model is used for a language model of the speech recognition system.

### Solution to Problem

A speech recognition system according to the present invention has: hypothesis search means which searches for an optimal solution of inputted speech data by generating a hypothesis which is a bundle of words which are searched for as recognition result candidates; self-repair decision means which calculates a self-repair likelihood of a word or a word sequence included in the hypothesis which is being searched for by the hypothesis search means, and decides whether or not self-repair of the word or the word sequence is performed; and transparent word hypothesis generation means which, when the self-repair decision means decides that the self-repair is performed, generates a transparent word hypothesis which is a hypothesis which regards as a transparent word a word or a word sequence included in a disfluency interval or a repair interval of a self-repair interval including the word or the word sequence, and the hypothesis search means searches for an optimal solution by including as search target hypotheses the transparent word hypothesis generated by the transparent word hypothesis generation means.

Further, a speech recognition method according to the present invention includes: in process in which hypothesis search means searches for an optimal solution of inputted speech data by generating a hypothesis which is a bundle of words which are searched for as recognition result candidates: calculating a self-repair likelihood of a word or a word sequence included in a hypothesis which is being searched for and deciding whether or not self-repair of the word or the word sequence is performed; and when it is decided that the self-repair is performed, generating a transparent word hypothesis which is a hypothesis which regards as a transparent word a word or a word sequence included in a disfluency interval or a repair interval of a self-repair interval including the word or the word sequence, and the hypothesis search means searches for an optimal solution by including as search target hypotheses the generated transparent word hypothesis.

Furthermore, a speech recognition program according to the present invention causes a computer in process of hypothesis search processing of searching for an optimal solution of inputted speech data by generating a hypothesis which is a bundle of words which are searched for as recognition result candidates to execute: self-repair decision processing of calculating a self-repair likelihood of a word or a word sequence included in a hypothesis which is being searched for and deciding whether or not self-repair of the word or the word sequence is performed; and transparent word hypothesis generation processing of, when it is decided that the self-repair is performed, generating a transparent word hypothesis which is a hypothesis which regards as a transparent word a word or a word sequence included in a disfluency interval or a repair interval of a self-repair interval including the word or the word sequence, and in the hypothesis search processing, the computer is caused to search for an optimal solution by including as search target hypotheses the generated transparent word hypothesis.

### Advantageous Effects of Invention

The present invention can provide a speech recognition system, a speech recognition method and a speech recognition program which are robust against self-repair even when an N-gram language model is used for a language model of the speech recognition system.

### BRIEF DESCRIPTION OF DRAWINGS

FIG. 1 It depicts a block diagram illustrating a configuration example of a speech recognition system according to a first exemplary embodiment.

FIG. 2 It depicts a flowchart illustrating an example of an operation of the speech recognition system according to the first exemplary embodiment.

FIG. 3 It depicts a block diagram illustrating a configuration example of a speech recognition system according to a second exemplary embodiment.

FIG. 4 It depicts a flowchart illustrating an example of an operation of the speech recognition system according to the second exemplary embodiment.

FIG. 5 It depicts an explanatory view illustrating an example of a hypothesis before a hypothesis is generated.

FIG. 6 It depicts an explanatory view illustrating another example of a hypothesis before a hypothesis is generated.

FIG. 7 It depicts an explanatory view illustrating an example of a hypothesis generated by regarding as a transparent word a word sequence of a disfluency interval and a repair interval.

FIG. 8 It depicts an explanatory view illustrating an example of a hypothesis generated by regarding as a transparent word a word sequence of a reparandum interval and a disfluency interval.

FIG. 9 It depicts a block diagram illustrating a summary of the present invention.

FIG. 10 It depicts a block diagram illustrating another configuration example of a speech recognition system according to the present invention.

### DESCRIPTION OF EMBODIMENTS

Hereinafter, exemplary embodiments of the present invention will be described with reference to the drawings.

### First Exemplary Embodiment

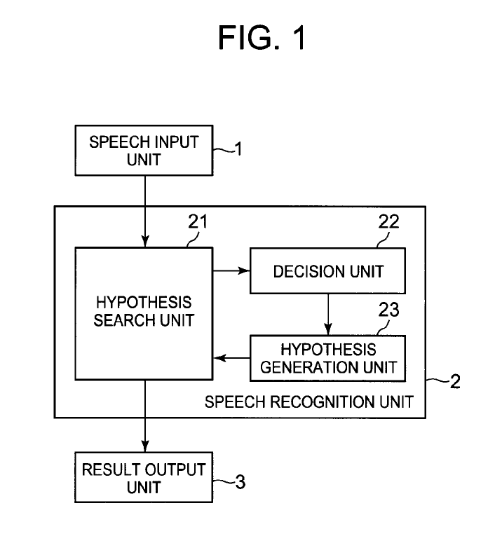

FIG. 1 depicts a block diagram illustrating a configuration example of a speech recognition system according to a first exemplary embodiment of the present invention. The speech recognition system illustrated in FIG. 1 has a speech input unit 1, a speech recognition unit 2 and a result output unit 3. Further, the speech recognition unit 2 has a hypothesis search unit 21, a decision unit 22 and a hypothesis generation unit 23.

The speech input unit 1 takes in a speech of a speaker as speech data. The speech data is taken in as, for example, a feature sequence of speech. The speech recognition unit 2 receives an input of the speech data taken in by the speech input unit 1, speech-recognizes the speech data and outputs a recognition result. The result output unit 3 outputs the speech recognition result.

The hypothesis search unit 21 calculates a likelihood of a hypothesis, expands a hypothesis which connects a phoneme and a word leading to each hypothesis, and searches for a solution.

The decision unit 22 hypothesizes a reparandum interval, a disfluency interval and a repair interval of a word bundle of each hypothesis, calculates a self-repair likelihood under this hypothesis and decides the self-repair likelihood equal to or more than a threshold.

The hypothesis generation unit 23 generates a hypothesis which regards words of a word sequence of the disfluency interval and the repair interval as transparent words.

For a self-repair likelihood calculation, indices such as acoustic information such as whether or not there is a silent pause or whether or not there is a rapid change in power, a pitch and a speaking rate, a type of a word of a disfluency interval, and similarity between words of a reparandum interval and a repair interval can be used. These indices may be individually used or integrated by linear combination and used.

In the present exemplary embodiment, the speech input unit 1 is realized by, for example, a speech input device such as a microphone. Further, the speech recognition unit 2 (including the hypothesis search unit 21, the decision unit 22 and the hypothesis generation unit 23) is realized by, for example, an information processing device such as a CPU which operates according to a program. Furthermore, the result output unit 3 is realized by, for example, an information processing device such as a CPU which operates according to a program, and an output device such as a monitor.

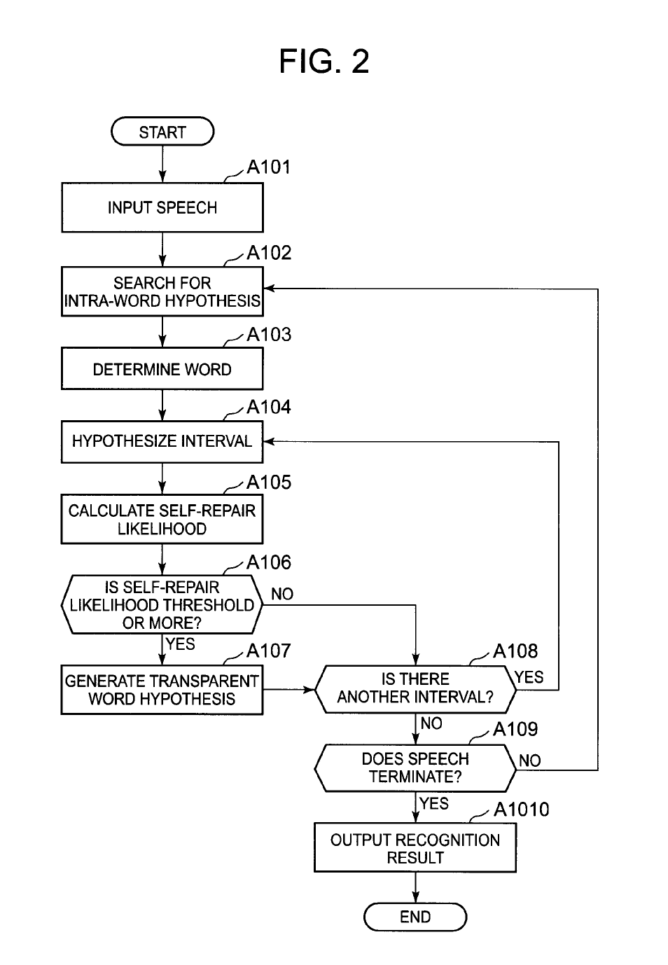

Next, an operation according to the present exemplary embodiment will be described. FIG. 2 depicts a flowchart illustrating an example of an operation of the speech recognition system according to the present exemplary embodiment. In an example illustrated in FIG. 2, the speech input unit 1 first takes in a speech of a speaker as speech data (step A101).

Next, the speech recognition unit 2 receives an input of the speech data taken in and speech-recognizes the speech data. Hereinafter, the hypothesis search unit 21 first calculates a likelihood of an intra-word hypothesis a word of which is not determined in the inputted speech data (step A102). Further, the hypothesis search unit 21 gives a language likelihood to a hypothesis which reaches a word termination, based on the determined word (step A103). In addition, the intra-word hypothesis refers to a unit (group) for regarding as one hypothesis a word of a phoneme with the same anlaut at a portion where which word is not determined, in process of searching for speech data from before on a time axis. Hence, at a stage of step A102, the hypothesis search unit 21 calculates a likelihood in form of “acoustic likelihood+approximated language likelihood” for the intra-word hypothesis the word of which is not determined. In addition, a language likelihood of a word bundle is accurately calculated and is added the “acoustic likelihood+language likelihood” when the hypothesis reaches a word termination and the word is determined, and then the flow proceeds to A103 in this case.

In process in which the hypothesis search unit 21 searches for a hypothesis, the decision unit 22 hypothesizes a combination of a reparandum interval, a disfluency interval and a repair interval in order from a determined word sequence, lists combinations and extracts a first combination (step A104). Meanwhile, the decision unit 22 hypothesizes the reparandum interval, the disfluency interval and the repair interval based on setting information of a self-repair interval set in advance by targeting at a word determined as one type of a word in the hypothesis (that is, the hypothesis which is being searched for) generated by the hypothesis search unit 21. The repair interval includes the determined word. The reparandum interval, the disfluency interval and the repair interval may be, for example, intervals of continuous single words, or may be intervals which accommodate L words in the reparandum interval, M words in the disfluency interval and N words in the repair interval and a plurality of combinations which the number of words of each interval can take may all be listed (L, M and N≧0). Hereinafter, the combinations of reparandum intervals, disfluency intervals and repair intervals listed in step A104 are referred to as hypothesis self-repair interval combinations, and intervals obtained by connecting these hypothesis self-repair interval combinations are referred to as hypothesis self-repair intervals in some cases.

Next, the decision unit 22 calculates a self-repair likelihood of the hypothesis self-repair interval combination extracted in step A104 (step A105). For a self-repair likelihood calculation, indices such as acoustic information such as whether or not there is a silent pause or whether or not there is a rapid change in power, a pitch and a speaking rate, a type of a word of a disfluency interval, and similarity between words of a reparandum interval and a repair interval can be used.

Further, the decision unit 22 decides whether or not the calculated self-repair likelihood is the threshold or more (step A106). When the self-repair likelihood is the threshold or more (Yes in step A106), the hypothesis generation unit 23 generates a hypothesis which regards as transparent words a reparandum interval and a repair interval in the hypothesis self-repair interval combination (step A107). Meanwhile, a transparent word refers to a word which is regarded as non-linguistic in speech recognition process. Hence, in case of a transparent word, upon calculation of a language likelihood of a hypothesis, this word is removed to calculate the likelihood. More specifically, the hypothesis search unit 21 calculates the language likelihood of the hypothesis by using the N-gram language model assuming that the word regarded as a transparent word does not include the word.

Meanwhile, when the self-repair likelihood is less than the threshold (No in step A106), the flow proceeds to step A108. In step A108, the decision unit 22 checks whether or not combinations which are not yet processed are left among the listed hypothesis self-repair interval combinations. When combinations which are not yet processed are left, the decision unit 22 returns to step A105, and extracts one combination from the rest of combinations (Yes in step A108). Meanwhile, when processing in steps A105 to A107 of all listed hypothesis self-repair interval combinations is completed (No in step A108), the flow proceeds to step A109.

In step A109, the hypothesis search unit 21 decides whether or not hypothesis search is finished to a speech termination. When the hypothesis search is not finished to the speech termination (No in step A109), the flow returns to step A102 and the hypothesis search unit 21 adds the hypothesis generated in step A107 as a hypothesis or replaces the hypothesis with a hypothesis which is decided to be corrected and performs hypothesis search of a next speech frame (processing in steps A102 to A108 of the next speech frame).

Meanwhile, when hypothesis search is finished to the speech termination (Yes in step A109), the result output unit 3 outputs a final maximum likelihood hypothesis as a speech recognition result by using the N-gram language model (step A110).

As described above, in the present exemplary embodiment, a self-repair interval of a hypothesis which is being searched for is gradually hypothesized, a self-repair likelihood is calculated, and a transparent word hypothesis is generated which dynamically regards as transparent words a disfluency interval and a repair interval of an interval which is decided to be corrected as a result, so that it is possible to precisely speech-recognize a reparandum interval of a speech including self-repair by using the N-gram language model.

### Second Exemplary Embodiment

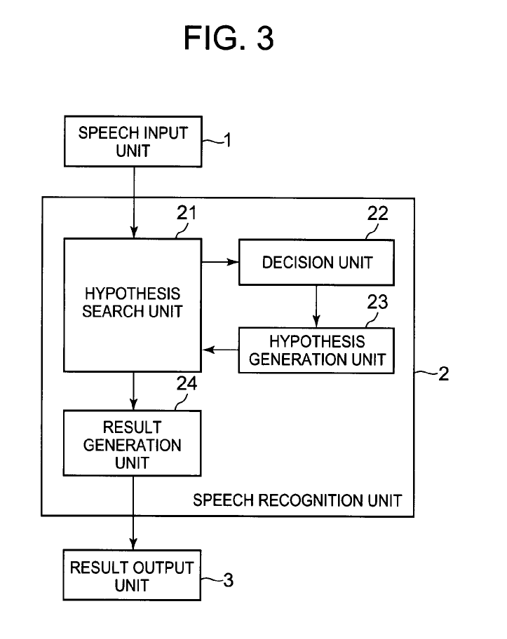

Next, a second exemplary embodiment of the present invention will be described. FIG. 3 depicts a block diagram illustrating a configuration example of a speech recognition system according to a second exemplary embodiment of the present invention. The speech recognition system illustrated in FIG. 3 differs from the first exemplary embodiment illustrated in FIG. 1 in that a speech recognition unit 2 has a result generation unit 24.

Further, in the present exemplary embodiment, the hypothesis generation unit 23 not only generates a hypothesis which regards words of a word sequence of a disfluency interval and a repair interval as transparent words, but also a hypothesis which regards words of a word sequence of a reparandum interval and a disfluency interval as transparent words.

The result generation unit 24 generates a speech recognition result obtained by combining a maximum likelihood hypothesis upon generation of a hypothesis which regards a word sequence of the reparandum interval side as a transparent word and a maximum likelihood hypothesis upon generation of a hypothesis which regards a word sequence of a repair interval side as a transparent word.

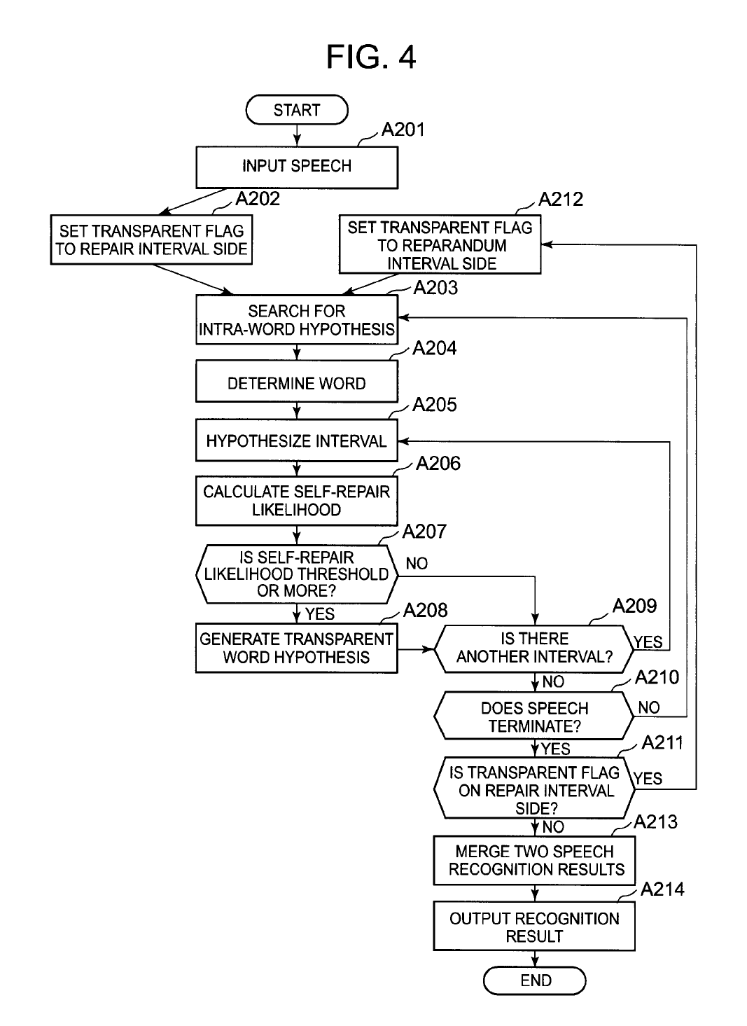

Next, an operation according to the present exemplary embodiment will be described. FIG. 4 depicts a flowchart illustrating an example of an operation of the speech recognition system according to the present exemplary embodiment. The operation according to the present exemplary embodiment differs from the operation according to the first exemplary embodiment in holding inside a system a transparent flag of deciding to generate a hypothesis which regards words of a word sequence of a reparandum interval and a disfluency interval on a reparandum interval side as transparent words or generate a hypothesis which regards words of a word sequence of a disfluency interval and a repair interval on a repair interval side as transparent words, and generating two maximum likelihood hypotheses of a maximum likelihood hypothesis upon generation of a hypothesis which regards the word sequence of the reparandum interval side as the transparent word and a maximum likelihood hypothesis upon generation of a hypothesis which regards the word sequence of the repair interval side as the transparent word.

In an example illustrated in FIG. 4, the speech input unit 1 first takes in a speech of a speaker as speech data (step A201). In the present exemplary embodiment, the speech recognition system sets a transparent flag held inside the system to the repair interval side at a timing when speech data is taken in (step A202). The transparent flag is information indicating on which one of the reparandum interval side and the repair interval side a transparent word is made.

Next, the hypothesis search unit 21 first calculates a likelihood of an intra-word hypothesis a word of which is not determined in the inputted speech data (step A203). Further, the hypothesis search unit 21 gives a language likelihood to a hypothesis which reaches a word termination, based on the determined word (step A204).

Meanwhile, the decision unit 22 hypothesizes a combination of a reparandum interval, a disfluency interval and a repair interval in order from a determined word sequence, lists combinations and extracts a first combination (step A205). These intervals may include determined words, the reparandum interval, the disfluency interval and the repair interval may be, for example, continuous single words or may be intervals which accommodate L words in the reparandum interval, M words in the disfluency interval and N words in the repair interval and a plurality of combinations may all be listed (L, M and N≧0).

Next, the decision unit 22 calculates self-repair likelihoods of the listed reparandum intervals, disfluency intervals and the repair intervals (step A206). For a self-repair likelihood calculation, indices such as acoustic information such as whether or not there is a silent pause or whether or not there is a rapid change in power, a pitch and a speaking rate, a type of a word of a disfluency interval, and similarity between words of a reparandum interval and a repair interval can be used.

The decision unit 22 decides whether or not the calculated self-repair likelihood is the threshold or more (step A207). When the self-repair likelihood is the threshold or more (Yes in step A207), the hypothesis generation unit 23 generates a hypothesis which regards the reparandum interval and the disfluency interval as transparent words if the transparent flag held inside the system is on the reparandum interval side, and generates a hypothesis which regards the disfluency interval and the repair interval as transparent words if the transparent flag is on the repair interval side (step A208). In addition, the hypothesis search unit 21 calculates a language likelihood of the hypothesis generated by the hypothesis generation unit 23 by using the N-gram language model based on decision that the hypothesis does not include a word regarded as a transparent word.

Meanwhile, when the self-repair likelihood is less than the threshold, the flow proceeds to step A209 (No in step A207).

In step S209, the decision unit 22 checks whether or not combinations of the listed reparandum intervals, disfluency intervals and repair intervals are left. When a combination of intervals is left (Yes in step A209), processing in steps A205 to A208 is performed for the combination of the interval.

Meanwhile, when a combination of intervals is not left (No in step A209), the flow proceed to step A210. In step A210, the hypothesis search unit 21 decides whether or not hypothesis search is finished to a speech termination, and, when hypothesis search is not finished to a speech termination (No in step A210), processing in steps A203 to A209 of a next speech frame is performed.

When hypothesis search is finished to a speech termination (Yes in step A210), whether or not a current transparent flag is on a repair interval side (step A211), the transparent flag is changed to a reparandum interval side if the transparent flag is on the repair interval side (step A212) and processing in steps A203 to A210 of inputted speech is performed likewise.

Further, when the current transparent flag is not on the repair interval side but on the reparandum interval side (No in step A211), the result generation unit 24 compares a maximum likelihood hypothesis of the hypothesis on the repair interval side which is previously processed and a hypothesis of the maximum likelihood hypothesis on the reparandum interval side which is subsequently processed. Furthermore, the result generation unit 24 checks whether a repair interval portion in the maximum likelihood hypothesis on the repair interval side is selected as a transparent word or a reparandum interval portion in the maximum likelihood on the reparandum interval side is selected as a transparent word, and generates for this self-repair interval a result obtained by combining these two maximum likelihood hypotheses (step A213). In addition, when the repair interval portion in the maximum likelihood hypothesis on the repair interval side is not selected as a transparent word or when a reparandum interval portion in the maximum likelihood hypothesis on the reparandum interval side is not selected as a transparent word, based on decision that these intervals are not self-repair intervals, the result generation unit 24 generates a result of the maximum likelihood hypothesis according to normal likelihood decision as the maximum likelihood hypothesis of the interval without performing processing of combining these intervals. That is, only when checking that two maximum likelihood hypotheses are corrected and therefore a hypothesis which regards a predetermined interval as a transparent word is selected as the maximum likelihood hypothesis, the result generation unit 24 combines the two maximum likelihood hypotheses of the self-repair interval of the hypothesis.

The result output unit 3 outputs the result generated by the result generation unit 24 (step A214).

As described above, in the present exemplary embodiment, maximum likelihood hypotheses upon generation of a transparent word hypothesis which regards a reparandum interval and a disfluency interval as transparent words and a transparent word hypothesis which regards a disfluency interval and a repair interval as transparent words are combined and outputted as a speech recognition result, so that it is possible to precisely speech-recognize a reparandum interval of a speech including self-repair even when the N-gram language model is used.

That is, by generating a transparent word hypothesis which regards the reparandum interval and the disfluency interval as transparent words, it is possible to use the N-gram language model of a word prior to the reparandum interval and words subsequent to the repair interval and the repair interval. Further, by generating a transparent word hypothesis which regards the disfluency interval and the repair interval as transparent words, it is possible to use the N-gram language model of a word prior to the reparandum interval and words subsequent to a reparandum interval and a repair interval. By taking into account a language likelihood of a hypothesis which includes these two types of transparent words, it is possible to output a faithful speech recognition result of uttered speech while the N-gram language model of the word sequence prior to the reparandum interval and word sequences subsequent to the reparandum interval, the disfluency interval, the repair interval and the repair interval are adequately adapted.

Further, upon an output of the hypothesis obtained by combining these two hypotheses as a speech recognition result, by assigning information of a self-repair interval to the speech recognition result, outputting the speech recognition result and using information assigned when the language analysis system analyzes the outputted speech recognition result, it is possible to more accurately analyze the language.

Furthermore, although the same processing as that on the repair interval side is performed on the reparandum interval side in the above description, a transparent word hypothesis which regards a word sequence of a reparandum interval and a disfluency interval as a transparent word may be generated for a portion which is likely to be a corrected portion by using again the transparent word hypothesis which regards a word sequence of the disfluency interval and the repair interval as a transparent word.

Still further, although the transparent word is generated first from the repair interval side in the above description, a transparent word may be generated from a reparandum interval side. Moreover, on a condition that maximum likelihood decision is separately performed, it is also possible to generate two types of transparent word hypotheses (a transparent word hypothesis which regards a word sequence of a disfluency interval and a repair interval as a transparent word and a transparent word hypothesis which regards a word sequence of the reparandum interval and the disfluency interval as a transparent word) by performing self-repair decision once.

### Example 1

Next, Example 1 of the present invention will be described with reference to the drawings. This example corresponds to the first exemplary embodiment. In this example, an operation will be described using as an example a case that a speech of “pen, umm, aoi no de kai te” (an utterance in Japanese: an English example illustrated in FIG. 6 is “a bed, you know, a brown one is made of woods”) is speech-recognized.

First, in step A101, the speech input unit 1 takes in an utterance of a speaker of “pen, umm, aoi no de kai te” (an utterance in Japanese: the English example is “a bed, you know, a brown one is made of woods”) as speech data.

Next, in step A102, the hypothesis search unit 21 receives an input of the speech data taken in, and calculates the likelihood of the intra-word hypothesis a word of which is not determined. This corresponds to, for example, calculating an acoustic likelihood of phoneme models of /i/ and /u/ with respect to the utterance of the phoneme of /i/ of a word of “kai te” (Japanese: the English example is “made of woods”) in a speech example, and adding the acoustic likelihood and a language likelihood of a preceding word bundle of the hypothesis such as “aoi no de” (Japanese: the English example is “a brown one is”).

Next, in step A103, the hypothesis search unit 21 gives the language likelihood to a hypothesis which reaches a word termination based on the determined word.

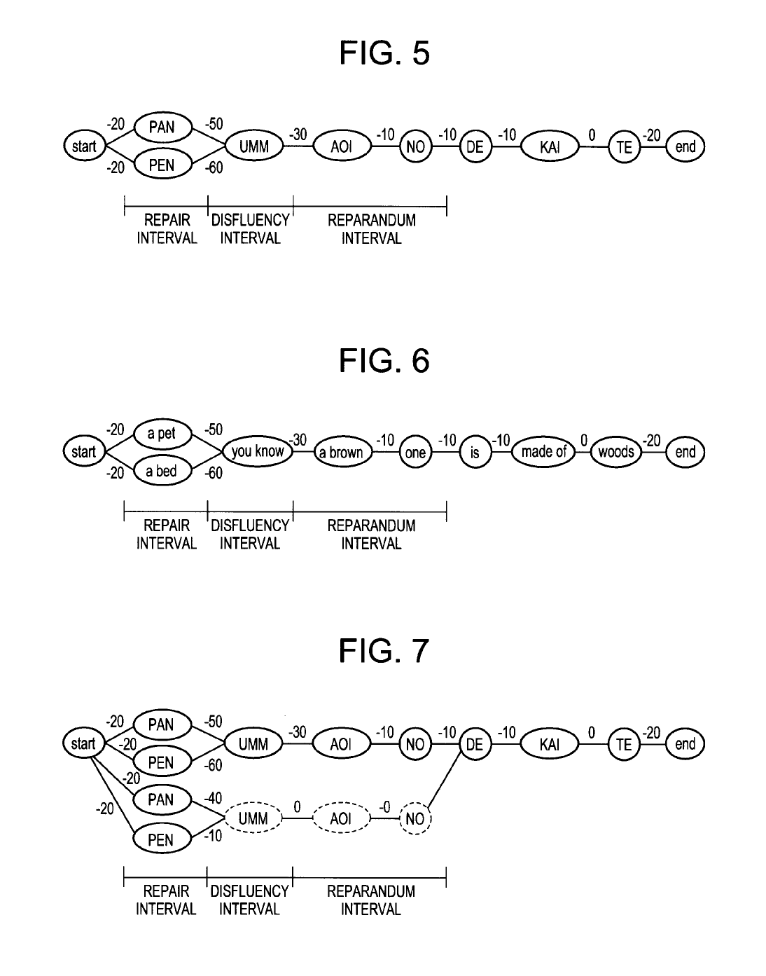

FIG. 5 is an explanatory view illustrating an example of a hypothesis searched for in this example. In FIG. 5, each ellipse indicates a word (word hypothesis) which is searched for as a recognition result candidate. Further, a numerical value assigned to each word hypothesis indicates a log likelihood of a word bundle in a state in which each word hypothesis is concatenated with a preceding word hypothesis. When a word of “umm” (Japanese: the English example is “you know”) is determined in this example, if a preceding utterance of “pen” (Japanese: the English example is “a bed”) is a word hypothesis of “pen” (Japanese: the English example is “a bed”), a language likelihood of a word bundle of “pen, umm” (Japanese: the English example is “a bed, you know”) is given. A log likelihood of “−60” is given in the example illustrated in FIG. 5. In addition, a hypothesis of a word bundle of “pan, umm” (Japanese: the English example is “a pet, you know”) is also simultaneously calculated, and a log likelihood of “−50” is given in this example.

Next, in step A104, the decision unit 22 lists combinations of reparandum intervals, disfluency intervals and repair intervals which are likely in the determined word sequences, and extracts a first combination. For example, the repair interval may include the word determined in step A103, the reparandum interval, the disfluency interval and the repair interval may be, for example, continuous single words and may be continuous intervals which accommodate L words in the reparandum interval, M words in the disfluency interval and N words in the repair interval, and all combinations of these may be listed. In case that, for example, the reparandum interval includes one word, the disfluency interval includes one word and the repair interval includes one word, in this speech example, when a word of “aoi” (Japanese: the English example is “a brown”) is determined in step A103, an interval combination of a reparandum interval including “pen” (Japanese: the English example is “abed”), a disfluency interval including “umm” (Japanese: the English example is “you know”) and a repair interval including “aoi” (Japanese: the English example is “a brown”) is listed.

Next, in step A105, the decision unit 22 calculates a self-repair likelihood of the hypothesis self-repair interval combination hypothesized and extracted in step A104. In this example, acoustic information such as whether or not there is a rapid change in the duration, power, a pitch and a speaking rate of a silent pause is used for an index of a self-repair likelihood. By modeling the acoustic information using learning data with which the reparandum interval, the disfluency interval and the repair interval are tagged in advance as, for example, a mixture Gaussian distribution in which temporal differentiations of the duration, the power, the pitch and the speaking rate of the silent pause are features, the likelihood with the model is calculated.

Next, in step A106, the decision unit 22 decides whether or not the self-repair likelihood of the extracted hypothesis self-repair interval is the threshold or more. The flow proceeds to step A107 when the self-repair likelihood is the threshold or more, and proceeds to step A108 when the self-repair likelihood is less than the threshold.

In step A107, for a hypothesis which includes the self-repair likelihood equal to or more than the threshold, the hypothesis generation unit 23 generates a hypothesis which regards a word sequence of a disfluency interval and a repair interval as a transparent word, and calculates again the likelihood by removing the word which is linguistically regarded as a transparent word. In addition, the hypothesis search unit 21 may calculate the language likelihood of the generated hypothesis again.

FIG. 7 illustrates an example of a hypothesis generated when a disfluency interval is hypothesized as “umm” (Japanese: the English example is “you know”), and the repair interval is hypothesized as “aoi” (Japanese: the English example is “a brown”) and “no” (Japanese: the English example is “one”). In the example in FIG. 7, a hypothesis which regards “umm” (Japanese: the English example is “you know”) in the disfluency interval and “aoi” (Japanese: the English example is “a brown”) and “no” (Japanese: the English example is “one”) in the repair interval as transparent words is newly generated based on the hypothesis illustrated in FIG. 5. For this hypothesis, the word of “umm” (Japanese: the English example is “you know”) in the disfluency interval and the words of “aoi” (Japanese: the English example is “a brown”) and “no” (Japanese: the English example is “one”) in the repair interval which are regarded as transparent words are removed, and a language likelihood is given by regarding that a word bundle is “pen de kai to (Japanese: the English example is “a bed is made of woods”). In this example, a log likelihood given to a word bundle of “umm, aoi no de” (Japanese: the English example is “you know, a brown one is”) is “0”, and a high log likelihood of “−10” is given to a word bundle of “pen de” (Japanese: the English example is “a bed is”). Further, in this example, an acoustic likelihood is not changed.

Next, in step A108, the decision unit 22 checks whether or not other combinations of reparandum intervals, disfluency intervals and repair intervals listed in step A104 are left. When the other combinations are left, the flow returns to step A104, and one combination is extracted from the rest of combinations and processing in steps A104 to A107 is repeated likewise.

Next, in step A109, the hypothesis search unit 21 decides whether or not hypothesis search is finished to a speech termination. Meanwhile, when hypothesis search does not reach the speech termination, the flow returns to step A102, and the hypothesis search unit 21 adds the hypothesis generated in step A107 as a hypothesis and performs hypothesis search of a next speech frame. When the hypothesis search reaches a speech termination, the flow proceeds to step A110.

In step A110, the result output unit 3 outputs a hypothesis which finally has a maximum likelihood and which is “pen de kai te” (Japanese: the English example is “a bed is made of woods”) as a speech recognition result.

By using this example and dynamically regarding as transparent words “umm, aoi no” (Japanese: the English example is “you know, a brown one”) which are regarded as the disfluency interval and the repair interval based on the calculated self-repair likelihood, a distance between “pen (Japanese: the English example is “a bed”) of the reparandum interval which is a word prior to the reparandum interval and “de” (Japanese: the English example is “is”) which is a word subsequent to the repair interval. Hence, the N-gram language model used upon conventional speech recognition can also find a language likelihood that “pen de kai te” (Japanese: the English example is “a bed is made of woods”) is more likely than “pan de kai te” (Japanese: the English example is “a pet is made of woods”). As a result, even when the N-gram language model is used, it is possible to precisely speech-recognize a reparandum interval of a speech including self-repair.

### Example 2

Next, Example 2 of the present invention will be described with reference to the drawings. This example corresponds to the second exemplary embodiment. Similar to Example 1, in this example, an operation will be described using as an example a case that a speech of “pen, umm, aoi no de kai te” (an utterance in Japanese: an English example is “a bed, you know, a brown one is made of woods”) is speech-recognized.

First, in step A201, the speech input unit 1 takes in a speech of a speaker “pen, umm, aoi no de kai te” (an utterance in Japanese: the English example is “a bed, you know, a brown one is made of woods”) as speech data.

Next, in step A202, the speech recognition system sets to a repair interval side a transparent flag of deciding to generate a hypothesis which regards as transparent words the words of the word sequence of the reparandum interval and the disfluency interval on a reparandum interval side, or generate a hypothesis which regards as transparent words the words of the word sequence of the disfluency interval and the repair interval on the repair interval side.

When this flag is set to the repair interval side, operations from steps A203 to A210 are the same as the operations from steps A102 to A109 according to Example 1.

Next, in step A211, a transparent flag is first set to the repair interval side, and the flow proceeds to step A212 and the transparent flag is set to the reparandum interval side in step A212. In next steps A203 to A207, the same operation as that in Example 1 is performed.

Next, in step A208, the transparent flag is the reparandum interval, and then the hypothesis generation unit 23 generates for a hypothesis which has a language likelihood equal to or more than a threshold a hypothesis which regards as the transparent word a word sequence of the reparandum interval and the disfluency interval. Further, the hypothesis generation unit 23 removes the word which is linguistically regarded as the transparent word, and calculates the likelihood again.

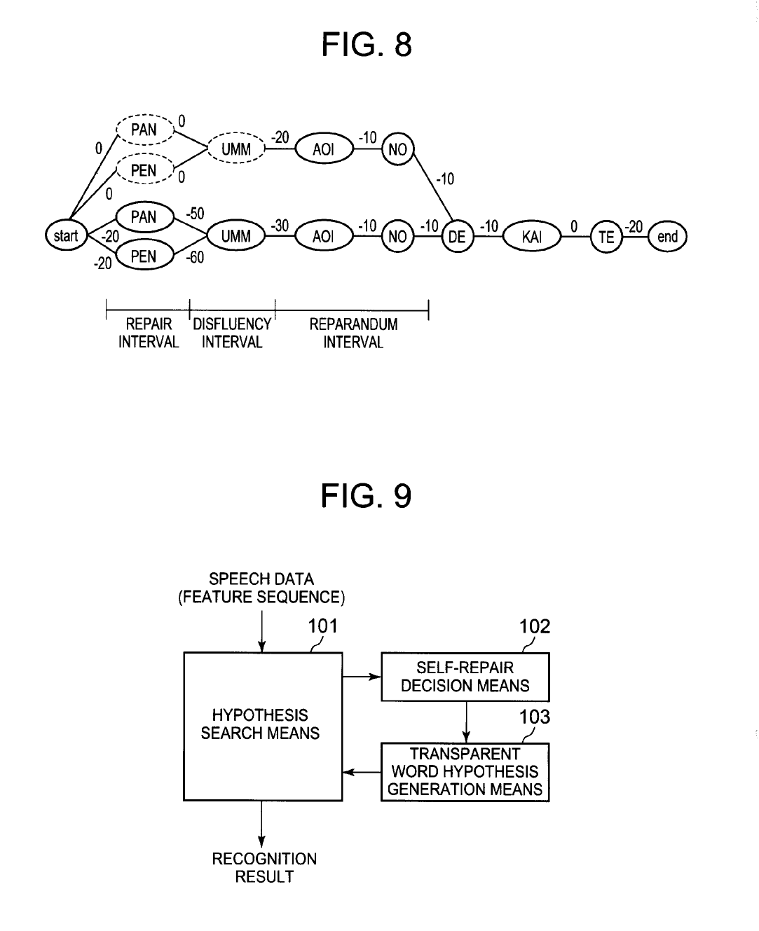

FIG. 8 is an explanatory view illustrating an example of a hypothesis generated when a reparandum interval is hypothesized as “pan” (Japanese: the English example is “a pet”) or “pen” (Japanese: the English example is “a bed”), and the disfluency interval is hypothesized as “umm” (Japanese: the English example is “you know”) in this utterance example. As illustrated in FIG. 8, in this example, “pan” (Japanese: the English example is “a pet”) or “pen” (Japanese: the English example is “a bed”) of the reparandum interval, and “umm” (Japanese: the English example is “you know”) of the disfluency interval are removed, a word bundle is regarded as “aoi no de kai te” (Japanese: the English example is “a brown one is made of woods”), and a language likelihood is given. Hence, log likelihoods given to a word bundle which is “pan, umm” (Japanese: the English example is “a pet, you know”) from a beginning of a sentence and a word bundle which is “pen, umm” (Japanese: the English example is “a bed, you know”) from a beginning of a sentence are “0”, and a high log likelihood of “−20” is given to a word bundle of the beginning of sentence and “aoi” (Japanese: the English example “a brown”).

Similar to Example 1, in step A209, whether or not there are other combinations is decided. When there are not other combinations, in step A210, whether or not hypothesis search is finished to a speech termination is decided. Meanwhile, when hypothesis search is finished to the speech termination, the flow proceeds to step A211. In next step A211, a transparent flag is set to a repair interval side, and then the flow proceeds to step A213.

In step A213, the result generation unit 24 generates a speech recognition result by using two maximum likelihood hypotheses of “pen de kai te” (Japanese: the English example is “a bed is made of woods”) which is a maximum likelihood hypothesis with a transparent flag set to the reparandum interval side and “aoi no de kai te” (Japanese: the English example is “a brown one is made of woods”) which is the maximum likelihood hypothesis with the transparent flag set to the repair interval side.

Meanwhile, the result generation unit 23 first extracts “pen” (Japanese: the English example is “a bed”) which is a word sequence of a reparandum interval which is not regarded as a transparent word in the maximum likelihood hypothesis with the transparent flag set to the repair interval side and “umm” (Japanese: the English example is “you know”) which is a word sequence of the transparent word of the disfluency interval. Next, the result generation unit 23 first extracts “umm” (Japanese: the English example is “you know”) which is a word sequence of the transparent word of the disfluency interval in the maximum likelihood hypothesis with the transparent flag set to the reparandum interval side and “aoi no” (Japanese: the English example is “a brown one”) which is a word sequence of a repair interval which is not regarded as a transparent word.

Further, the result generation unit 23 generates a speech recognition result which is “pen, umm, aoi no de kai te” (Japanese: the English example is “a bed, you know, a brown one is made of woods”) by arranging a word sequence in order of the reparandum interval, the disfluency interval and the repair interval around a common disfluency interval and arranging a common word sequence subsequent to the repair interval. In this case, by combining a word bundle in a self-repair interval indicated by a maximum likelihood hypothesis which is decided by a series of search processing of generating and searching for a transparent word hypothesis which regards a reparandum interval side as a transparent word, and a word bundle in the self-repair interval indicated by the maximum likelihood which is decided by a series of search processing of generating and searching for a transparent word hypothesis which regards the repair interval side as a transparent word, a speech recognition result which indicates these word bundles including all words in the self-repair interval without regarding the words as transparent words only needs to be generated.

Finally, in step A214, the result generated in step A213 is outputted. Meanwhile, “pen, umm, aoi no de kai te” (Japanese; the English example is “a bed, you know, a brown one is made of woods”) is outputted as a speech recognition result.

In this example, by creating a speech recognition result by combining a transparent word hypothesis which regards a reparandum interval side as a transparent word and a maximum likelihood hypothesis of a transparent word hypothesis which regards a repair interval side as a transparent word, the N-gram language model of a word sequence prior to a reparandum interval and a word sequence subsequent to a reparandum interval, a disfluency interval, a repair interval and a repair interval is adequately adapted. Consequently, it is possible to reduce false recognition of a speech including self-repair.

Further, instead of outputting only text information as a speech recognition result, it is also possible to assign information of the reparandum interval to “pen” (Japanese: the English example is “a bed”), information of the disfluency interval to “umm” (Japanese: the English example is “you know”) and information of a repair interval to “aoi no” (Japanese: the English example is “a brown one”) to a speech recognition result to output. By outputting the speech recognition result to which information of the reparandum interval, the disfluency interval and the repair interval is assigned, it is possible to more accurately analyze the language by using these pieces of information upon, for example, analysis of this speech recognition result by means of the language analysis system.

Next, a summary of the present invention will be described. FIG. 9 depicts a block diagram illustrating the summary of the present invention. As illustrated in FIG. 9, the speech recognition device according to the present invention has hypothesis search means 101, decision means 102 and transparent word hypothesis generation means 103.

The hypothesis search means 101 (for example, the hypothesis search unit 21) searches for an optimal solution of inputted speech data by generating a hypothesis which is a bundle of words which are searched for as recognition result candidates. Further, the hypothesis search means 101 searches for the optimal solution by including as search target hypothesis the transparent word hypothesis generated by the transparent word hypothesis generation means 103 described below.

The self-repair decision means 102 (for example, the decision unit 22) calculates a self-repair likelihood of a word or a word sequence included in the hypothesis which is being searched for by the hypothesis search means 101, and decides whether or not self-repair of the word or the word sequence is performed.

When the self-repair decision means 102 decides that the self-repair is performed, the transparent word hypothesis generation means 103 (for example, the hypothesis generation unit 23) generates a transparent word hypothesis which is a hypothesis which regards as a transparent word a word or a word sequence included in a disfluency interval or a repair interval of a self-repair interval including the word or the word sequence.

Further, by hypothesizing for the word or the word sequence included in the hypothesis which is being searched for by the hypothesis search means 101 a combination of the reparandum interval which includes the word or the word sequence in the repair interval, the disfluency interval and the repair interval, calculating a self-repair likelihood per hypothesized combination of the reparandum interval, the disfluency interval and the repair interval, and deciding whether or not the calculated self-repair likelihood is a predetermined threshold or more, the self-repair decision means 102 may decide whether or not the self-repair of the combination is performed, and the transparent word hypothesis generation means 103 may generate a hypothesis which regards as the transparent word the word or the word sequence included in the disfluency interval or the repair interval of the combination which is decided by the self-repair decision means 102 to be corrected.

Furthermore, the transparent word hypothesis generation means 103 may generate for a transparent word hypothesis a reparandum interval side transparent word hypothesis which regards as the transparent word the word or the word sequence included in the reparandum interval or the disfluency interval, and a repair interval side transparent word hypothesis which regards as a transparent word the word or the word sequence included in the disfluency interval or the repair interval, and the hypothesis search means 101 may search for an optimal solution by including as search target hypotheses the reparandum interval side transparent word hypothesis and the repair interval side transparent word hypothesis generated by the transparent word hypothesis generation means.

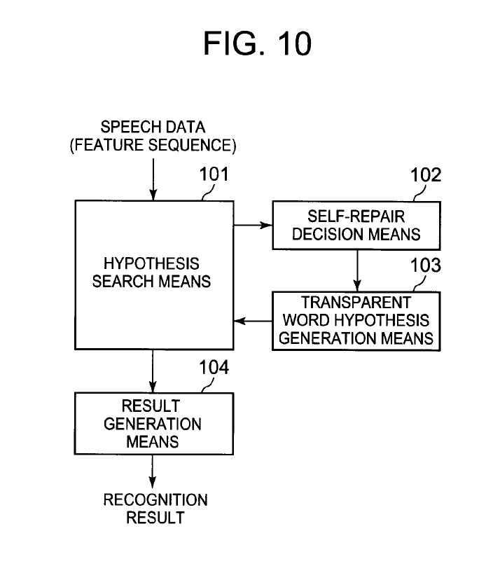

Still further, FIG. 10 depicts a block diagram illustrating another configuration example of a speech recognition system according to the present invention. As illustrated in FIG. 10, the speech recognition system according to the present invention may have result generation means 104 (for example, a result generation unit 24) which generates a speech recognition result. In such a case, the hypothesis search means 101 may perform first search processing of searching for the optimal solution by including as the search target hypotheses the generated reparandum interval side transparent word hypothesis, and second search processing of searching for the optimal solution by including as the search target hypotheses the generated repair interval side transparent word hypothesis, and the result generation means 104 may output a speech recognition result obtained by combining a speech recognition result of the first search processing, and a speech recognition result of the second search processing.

Further, when a maximum likelihood hypothesis indicated by the speech recognition result of the first search processing is the reparandum interval side transparent word hypothesis, and a maximum likelihood hypothesis indicated by the speech recognition result of the second search processing is the repair interval side transparent word hypothesis, for an interval which is decided to be corrected, the result generation means 104 may combine a word bundle in a self-repair interval indicated by the reparandum interval side transparent word hypothesis and a word bundle in the self-repair interval indicated by the repair interval side transparent word hypothesis, and output a speech recognition result which indicates a word bundle including all words in the self-repair interval without regarding the words as transparent words.

Furthermore, although not illustrated, the speech recognition system according to the present invention may have result output means (for example, a result output unit 3) which outputs a speech recognition result, and the result output means may output not only text information indicated by a word bundle of a maximum likelihood hypothesis but also a speech recognition result which is assigned information of a reparandum interval, the disfluency interval or the repair interval.

Still further, in a speech recognition method according to the present invention, in process in which hypothesis search means searches for an optimal solution of inputted speech data by generating a hypothesis which is a bundle of words which are searched for as recognition result candidates: when it is decided that the self-repair is performed, transparent word hypothesis generation means may generate a reparandum interval side transparent word hypothesis which regards as a transparent word a word or a word sequence included in a reparandum interval or a disfluency interval, and a repair interval side transparent word hypothesis which regards as the transparent word the word or the word sequence included in the disfluency interval or a repair interval, hypothesis search means may perform first search processing of searching for the optimal solution by including as the search target hypotheses the generated reparandum interval side transparent word hypothesis, and second search processing of searching for the optimal solution by including as the search target hypotheses the generated repair interval side transparent word hypothesis; and result output means may output a speech recognition result obtained by combining a speech recognition result of the first search processing, and a speech recognition result of the second search processing.

Moreover, a speech recognition program according to the present invention may cause a computer to execute: self-repair decision processing of calculating a self-repair likelihood of a word or a word sequence included in a hypothesis which is being searched for and deciding whether or not self-repair of the word or the word sequence is performed; first transparent word hypothesis generation processing of, when it is decided that the self-repair is performed, generating a reparandum interval side transparent word hypothesis which regards as a transparent word the word or the word sequence included in a reparandum interval or a disfluency interval; second transparent word hypothesis generation processing of, when it is decided that the self-repair is performed, generating a repair interval side transparent word hypothesis which regards as the transparent word the word or the word sequence included in the disfluency interval or a repair interval; first search processing of searching for the optimal solution by including as search target hypotheses the generated reparandum interval side transparent word hypothesis; second search processing of searching for the optimal solution by including as the search target hypotheses the generated repair interval side transparent word hypothesis; and result output processing of outputting a speech recognition result obtained by combining a speech recognition result of the first search processing, and a speech recognition result of the second search processing.

Although the present invention has been described above with reference to the exemplary embodiments and the examples, the present invention is by no means limited to the above exemplary embodiments and examples. Configurations and details of the present invention can be variously changed within a scope of the present invention one of ordinary skill in art can understand.

This application claims priority to Japanese Patent Application No. 2011-002307 filed on Jan. 7, 2011, the entire contents of which are incorporated by reference herein.

### INDUSTRIAL APPLICABILITY

The present invention can be widely used in a general speech recognition system. Particularly, the present invention is suitably applicable to a speech recognition system which recognizes speech uttered by a person to a person as in lecture speech or dialogue speech.

### REFERENCE SIGNS LIST

1 speech input unit
2 speech recognition unit
21 hypothesis search unit
22 decision unit
23 hypothesis generation unit
24 result generation unit
3 result output unit
101 hypothesis search means
102 decision means
103 transparent word hypothesis generation means
104 result generation means

1. A speech recognition system comprising:
a hypothesis search unit which searches for an optimal solution of inputted speech data by generating a hypothesis which is a bundle of words which are searched for as recognition result candidates;
a self-repair decision unit which calculates a self-repair likelihood of a word or a word sequence included in the hypothesis which is being searched for by the hypothesis search unit, and decides whether or not self-repair of the word or the word sequence is performed; and
a transparent word hypothesis generation unit which, when the self-repair decision unit decides that the self-repair is performed, generates a transparent word hypothesis which is a hypothesis which regards as a transparent word a word or a word sequence included in a disfluency interval or a repair interval of a self-repair interval including the word or the word sequence,
wherein the hypothesis search unit searches for an optimal solution by including as search target hypotheses the transparent word hypothesis generated by the transparent word hypothesis generation unit.

2. The speech recognition system according to claim 1, wherein:
the self-repair decision unit hypothesizes for the word or the word sequence included in the hypothesis which is being searched for by the hypothesis search unit a combination of a reparandum interval which includes the word or the word sequence in the repair interval, the disfluency interval and the repair interval, calculates a self-repair likelihood per hypothesized combination of the reparandum interval, the disfluency interval and the repair interval, decides whether or not the calculated self-repair likelihood is a predetermined threshold or more and thereby decides whether or not the self-repair of the combination is performed; and
the transparent word hypothesis generation unit generates the hypothesis which regards as the transparent word the word or the word sequence included in the disfluency interval or the repair interval of the combination which is decided by the self-repair decision unit to be corrected.

3. The speech recognition system according to claim 1, wherein:
the transparent word hypothesis generation unit generates for a transparent word hypothesis a reparandum interval side transparent word hypothesis which regards as the transparent word the word or the word sequence included in a reparandum interval or the disfluency interval, and a repair interval side transparent word hypothesis which regards as the transparent word the word or the word sequence included in the disfluency interval or the repair interval; and
the hypothesis search unit searches for the optimal solution by including as the search target hypotheses the reparandum interval side transparent word hypothesis and the repair interval side transparent word hypothesis generated by the transparent word hypothesis generation unit.

4. The speech recognition system according to claim 3, further comprising a result generation unit which generates a speech recognition result, wherein:
the hypothesis search unit performs first search processing of searching for the optimal solution by including as the search target hypotheses the generated reparandum interval side transparent word hypothesis, and second search processing of searching for the optimal solution by including as the search target hypotheses the generated repair interval side transparent word hypothesis; and
the result generation unit generates a speech recognition result obtained by combining a speech recognition result of the first search processing, and a speech recognition result of the second search processing.

5. The speech recognition system according to claim 4, wherein, when a maximum likelihood hypothesis indicated by the speech recognition result of the first search processing is the reparandum interval side transparent word hypothesis, and a maximum likelihood hypothesis indicated by the speech recognition result of the second search processing is the repair interval side transparent word hypothesis, for an interval which is decided to be corrected, the result generation unit combines a word bundle in a self-repair interval indicated by the reparandum interval side transparent word hypothesis and a word bundle in the self-repair interval indicated by the repair interval side transparent word hypothesis, and generates a speech recognition result which indicates a word bundle including all words in the self-repair interval without regarding the words as transparent words.

6. The speech recognition system according to claim 1, further comprising a result output unit which outputs a speech recognition result,
wherein the result output unit outputs not only text information indicated by a word bundle of a maximum likelihood hypothesis but also a speech recognition result which is assigned information of a reparandum interval, the disfluency interval or the repair interval.

7. A speech recognition method comprising in process in which a hypothesis search unit searches for an optimal solution of inputted speech data by generating a hypothesis which is a bundle of words which are searched for as recognition result candidates:
calculating a self-repair likelihood of a word or a word sequence included in a hypothesis which is being searched for and deciding whether or not self-repair of the word or the word sequence is performed; and
when it is decided that the self-repair is performed, generating a transparent word hypothesis which is a hypothesis which regards as a transparent word a word or a word sequence included in a disfluency interval or a repair interval of a self-repair interval including the word or the word sequence,
wherein the hypothesis search unit searches for an optimal solution by including as search target hypotheses the generated transparent word hypothesis.

8. The speech recognition method according to claim 7, wherein, in process in which the hypothesis search unit searches for the optimal solution of the inputted speech data by generating the hypothesis which is the bundle of the words which are searched for as the recognition result candidates:
when it is decided that the self-repair is performed, a transparent word hypothesis generation unit generates a reparandum interval side transparent word hypothesis which regards as a transparent word a word or a word sequence included in a reparandum interval or a disfluency interval, and a repair interval side transparent word hypothesis which regards as the transparent word the word or the word sequence included in the disfluency interval or a repair interval,
the hypothesis search unit performs first search processing of searching for the optimal solution by including as the search target hypotheses the generated reparandum interval side transparent word hypothesis, and second search processing of searching for the optimal solution by including as the search target hypotheses the generated repair interval side transparent word hypothesis; and
the result output unit outputs a speech recognition result obtained by combining a speech recognition result of the first search processing, and a speech recognition result of the second search processing.

9. A non-transitory computer readable information recording medium storing a speech recognition program, when executed by a processor, performs a method for,
in process of hypothesis search processing of searching for an optimal solution of inputted speech data by generating a hypothesis which is a bundle of words which are searched for as recognition result candidates:
calculating a self-repair likelihood of a word or a word sequence included in a hypothesis which is being searched for and deciding whether or not self-repair of the word or the word sequence is performed; and
generating a transparent word hypothesis which is a hypothesis which regards as a transparent word a word or a word sequence included in a disfluency interval or a repair interval of a self-repair interval including the word or the word sequence when it is decided that the self-repair is performed,
searching for an optimal solution by including as search target hypotheses the generated transparent word hypothesis.

10. The non-transitory computer readable information recording medium according to claim 9, further comprising:
self-repair decision processing of calculating a self-repair likelihood of a word or a word sequence included in a hypothesis which is being searched for and deciding whether or not self-repair of the word or the word sequence is performed;
first transparent word hypothesis generation processing of generating a reparandum interval side transparent word hypothesis which regards as a transparent word the word or the word sequence included in a reparandum interval or a disfluency interval, when it is decided that the self-repair is performed;
second transparent word hypothesis generation processing of generating a repair interval side transparent word hypothesis which regards as the transparent word the word or the word sequence included in the disfluency interval or a repair interval, when it is decided that the self-repair is performed;
first search processing of searching for the optimal solution by including as search target hypotheses the generated reparandum interval side transparent word hypothesis;
second search processing of searching for the optimal solution by including as the search target hypotheses the generated repair interval side transparent word hypothesis; and
result output processing of outputting a speech recognition result obtained by combining a speech recognition result of the first search processing, and a speech recognition result of the second search processing.

11. The speech recognition system according to claim 2, wherein:
the transparent word hypothesis generation unit generates for a transparent word hypothesis a reparandum interval side transparent word hypothesis which regards as the transparent word the word or the word sequence included in a reparandum interval or the disfluency interval, and a repair interval side transparent word hypothesis which regards as the transparent word the word or the word sequence included in the disfluency interval or the repair interval; and
the hypothesis search unit searches for the optimal solution by including as the search target hypotheses the reparandum interval side transparent word hypothesis and the repair interval side transparent word hypothesis generated by the transparent word hypothesis generation unit.

12. The speech recognition system according to claim 2, further comprising a result output unit which outputs a speech recognition result,
wherein the result output unit outputs not only text information indicated by a word bundle of a maximum likelihood hypothesis but also a speech recognition result which is assigned information of a reparandum interval, the disfluency interval or the repair interval.
